(19) United States
(12) Patent Application Publication
(10) Pub. No.: US 2012/0215720 A1
(43) Pub. Date: Aug. 23, 2012

(54) SYSTEM AND METHOD FOR FACILITATING CONNECTIONS AND COMPLIANCE INVOLVING SERVICE PROVIDERS IN THE SECURITIES INDUSTRY

(76) Inventor: Jervis Bennett Hough, Sunny Isles Beach, FL (US)

(21) Appl. No.: 13/400,494

(22) Filed: Feb. 20, 2012

Related U.S. Application Data
(60) Provisional application No. 61/444,191, filed on Feb. 18, 2011.

(51) Int. Cl. G06Q 40/06

(52) U.S. Cl. 705/36 R

(57) ABSTRACT

The present invention generally relates to facilitating connections and compliance between individuals, business entities and service providers in the securities industry. Specifically, this invention relates to a system and method for facilitating the virtual connection of service providers in the securities industry with broker dealers, registered investment advisory firms private equity groups, hedge funds, other service providers and consultants through a computer based system that processes related communications and data via one or more networks and may be delivered to a user through one or more computing devices.

### CROSS-REFERENCE TO RELATED APPLICATIONS

This application claims the benefit of the following provisional applications, each of which is hereby incorporated by reference in its entirety: U.S. Pat. App. No. 61/444,191 filed on Feb. 18, 2011 and entitled “SYSTEM AND METHOD FOR FACILITATING CONNECTIONS AND COMPLIANCE INVOLVING SERVICE PROVIDERS IN THE SECURITIES INDUSTRY.”

### FIELD OF THE INVENTION

The present invention generally relates to facilitating connections and compliance between individuals, business entities and service providers in the securities industry. Specifically, this invention relates to a system and method for facilitatin the virtual connection of service providers in the securities industry with broker dealers, registered investment advisory firms private equity groups, hedge funds, other service providers and consultant through a computer based system that processes related communications and data via one or more networks and may be delivered to a user through one or more computing devices.

### BACKGROUND

Businesses in the securities industries have long been based on connections based on personal and business contacts. Particular individuals will know and become accustom to doing business with certain professionals to provide their service needs. Unfortunately, this model has become outdated and cumbersome as the pace of business and securities transactions increases every day.

One complication that can arise in attempting to dynamically select and use new service providers is that a person typically must go through a cumbersome verification process to make sure that the service provider would not otherwise be restricted from providing the service based on one or more criteria (e.g., conflict of interest, in possession of confidential information that may violate insider trading laws or other securities regulations).

Additionally, quality and reputation are also hard to measure with new contacts, unless the service provider has already built a significant reputation in the marketplace. This can be difficult as many of the marketplaces are fragmented and specialized. In this manner, even seasoned service providers may be relatively unknown outside of their specialty or location.

Therefore, there is need in the art for a computer based system capable of facilitating the virtual connection of service providers in the securities industry with broker dealers, registered investment advisory firms private equity groups, hedge funds, other service providers and consultants. These and other features and advantages of the present invention will be explained and will become obvious to one skilled in the art through the summary of the invention that follows.

### SUMMARY OF THE INVENTION

Accordingly, it is an aspect of the present invention to provide a computer based system capable of facilitating the virtual connection of service providers in the securities industry with broker dealers, registered investment advisory firms private equity groups, hedge funds, other service providers and consultants.

According to an embodiment of the present invention, a web-based system for facilitating a virtual connection of service providers in a securities industry with a user includes, a data store configured to store a plurality of stored data points; an application server operatively connected to said data store; a first memory in the application server, said first memory containing computer-executable code stored in non-transitory memory that, when processed by said application server, performs steps comprising: receiving a request to receive proposals for provision of one or more services related to securities business, from said user, wherein said request comprises one or more data points; generating a project submission, comprising project details, from said request to receive proposals based at least in part on said one or more data points and said plurality of stored data points, wherein said project submission may be sent to or searched by providers of securities transaction services; providing said project details to one or more securities transaction service providers; receiving one or more proposals from one or more of said one or more securities transaction service providers; receiving a set of one or more selected securities transaction service providers from said user; and providing to said user and said set of one or more selected securities transaction service providers one or more collaborative tools.

According to an embodiment of the present invention, the one or more securities transaction service providers have been previously verified by the web-based system.

According to an embodiment of the present invention, the one or more services related to securities businesses comprise one or more of a broker dealer, a registered investment advisory firm, a private equity group, a hedge fund and a consultant.

According to an embodiment of the present invention, The web-based system of claim 1, wherein said plurality of data points comprise one or more of a location of a project, a completion timeline, a required size of a service provider, a preferred size of a service provider, financial information related to the user and contact information.

According to an embodiment of the present invention, the web-based system may include a second memory in the application server, the second memory containing computer-executable code stored in non-transitory memory that, when processed by said application server, performs steps comprising: verifying said one or more securities transaction service providers; and restricting access to said project details to at least one of said one or more securities transaction service providers.

According to an embodiment of the present invention, the restriction is based at least in part on a conflict identified between said user and said at least one of said one or more securities transaction service providers.

According to an embodiment of the present invention, the restriction is based at least in part on a conflict identified between said at least one of said one or more securities transaction service providers and a second one of said one or more securities transaction service providers.

According to an embodiment of the present invention, a web-based method for facilitating a virtual connection of service providers in a securities industry with a user includes the steps of: receiving, at an application server, a request to receive proposals for provision of one or more services related to securities business, from a user, wherein said request comprises one or more data points; generating a project submission, comprising project details, from said request to receive proposals based at least in part on said one or more data points and a plurality of stored data points, stored in a data store operably connected to said application server, wherein said project submission may be sent to or searched by providers of securities transaction services; providing, from said application server, said project details to one or more securities transaction service providers; receiving, at said application server, one or more proposals from one or more of said one or more securities transaction service providers; receiving, at said application server, a set of one or more selected securities transaction service providers from said user; and providing, from said application server, to said user and said set of one or more selected securities transaction service providers one or more collaborative tools.

According to an embodiment of the present invention, the web-based method may include the steps of: verifying said one or more securities transaction service providers; and restricting access to said project details to at least one of said one or more securities transaction service providers.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention; and

FIG. 3 is a flowchart of an exemplary method in accordance with an embodiment of the present invention.

### DETAILED SPECIFICATION

The present invention generally relates to facilitating connections and compliance between individuals, business entities and service providers in the securities industry. Specifically, this invention relates to a system and method for facilitating the virtual connection of service providers in the securities industry with broker dealers, registered investment advisory firms private equity groups, hedge funds, other service providers and consultants through a computer based system that processes related communications and data via one or more networks and may be delivered to a user through one or more computing devices.

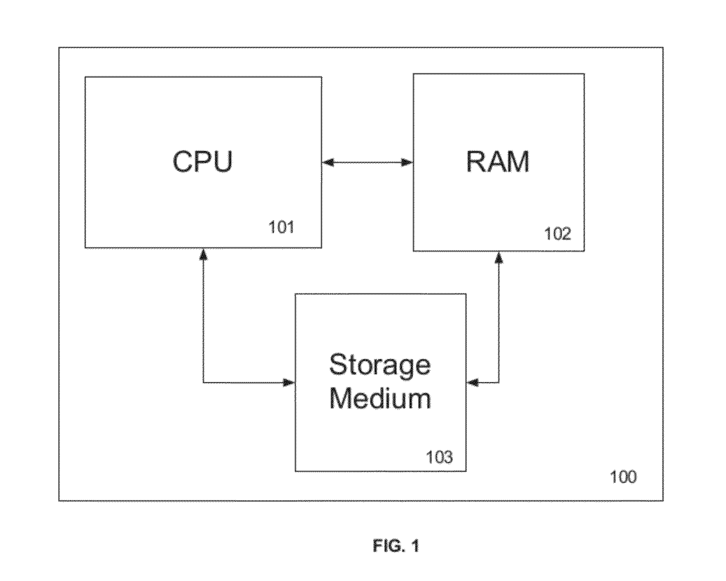

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

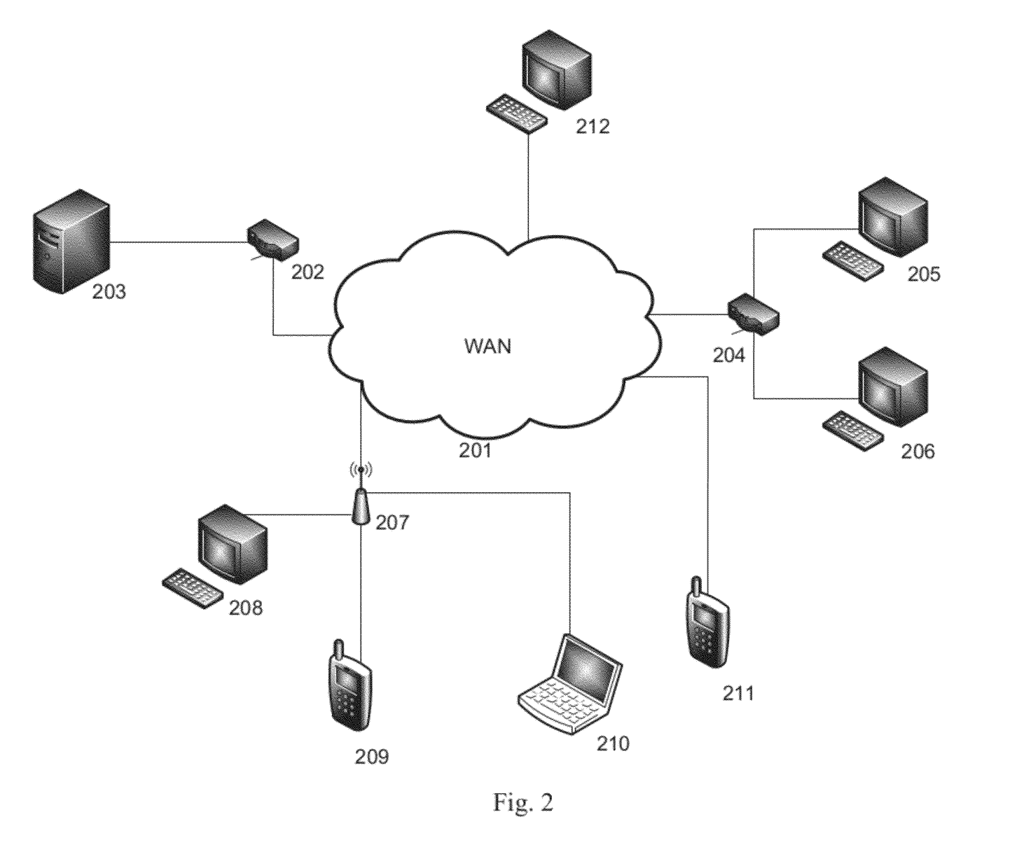

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

According to an embodiment of the present invention, an individual or organization may signup to become a user of the system herein provided. In an exemplary embodiment, an individual or organization would go through a registration process, whereby they would provide identifying information to be stored in application server 103. This identifying information may be used, for instance, to identify the user, verify certifications or credentials, secure their login or process financial compliance. One of ordinary skill in the art would appreciate there are numerous ways to provide and manage registration processes, and embodiments of the present invention are contemplated for use with any method for providing and managing registration processes.

According to an embodiment of the present invention, a registered user may be i) an individual or organization seeking services related to securities compliance (e.g., the creation of a securities related entities), ii) an individual or organization capable of providing securities transaction services, or iii) any combination thereof One of ordinary skill in the art would appreciate that there are numerous forms of securities transactions and entities that carry out such transactions, and embodiments of the present invention are contemplated for use with any form of registered or non-registered securities entity.

According to an embodiment of the present invention, a registered user that is an organization may be able to structure their user account in such a way as to provide multiple tiers, departments, structures and authorities to each individual or specific subunit of the organization. In this manner, an organization may be able to appropriately represent their organizational structure through the system and provide or receive services based on the needs or skills of any specific individual or subunit of the organization.

According to an embodiment of the present invention, once registered, the system and methods herein described provide the registered user with numerous methods and functions for connecting and transacting between providers of securities compliance services and those in need of securities transaction compliance. Set forth below are some of the functions and methods provided by the present invention.

According to an embodiment of the present invention, a registered user comprised of a individual or organization may submit a request to receive proposals for the provision of one or more services related to securities business Securities business services include, but are not limited to, broker-dealer services, due diligence services, forensic accounting services, focus report review and filing services, net capital calculation and analysis services, audit services, compliance services and balance and income sheet preparation services. One of ordinary skill in the art would appreciate that there are numerous securities transaction services a user could post a request for in accordance with embodiments of the present invention, and embodiments of the present invention are contemplated for use with any type of services related to securities compliance.

The submission may be comprised of a plurality of data points that help identify the particular securities compliance service type needed and specific requirements regarding the submission and the related project. Data points may include, but are not limited to, location of project, completion timeline, required/preferred size of service provider, financial information related to the submitting user and contact information. One of ordinary skill in the art would appreciate that there are numerous data points that may be used in accordance with embodiments of the present invention, and embodiments of the present invention are contemplated for use with any type and number of data points.

Once a request for proposals is submitted, the project submission may be sent to or searched by providers of securities transaction services. Alerts regarding project submissions may be sent to registered users and service providers in any number of ways. Methods for sending alert include, but are not limited to, e-mail, facsimile, voice call, SMS, instant messaging and social networking mediums. One of ordinary skill in the art would appreciate that there are numerous methods for sending alerts in accordance with embodiments of the present invention, and embodiments of the present invention are contemplated for use with any method for sending alerts.

Visibility of project submissions may be limited to only those registered service providers who are qualified or capable of handling the particular project. Qualifications and capabilities may be set and verified in numerous manners. First, the user requesting proposals may set specific data points related to characteristics they are looking for in a service provider. For instance, a user requesting proposals may request that service providers be registered or certified to provide specific services (e.g., legal, compliance) in their specific jurisdiction (e.g., state, county, country). With this requirement, providers registrations or certifications with that specific jurisdiction may be previously verified through automated or manual processes enacted through modules of the system herein presented. One of ordinary skill in the art would appreciate that there are numerous qualifications and verification methods that may be utilized in accordance with embodiments of the present invention, and embodiments of the present invention are contemplated for use with any type of qualification and manner of verifying said qualification.

Optionally, visibility of project submissions may be limited to only those registered users who may not be barred from handling the particular project. The provision of securities services is highly regulated and there are numerous barriers that may be raised in any given project that would prevent one or more providers of securities or brokerage services from working on or consulting for that specific project. For instance, work on previous projects for third-party organizations or individuals may create a conflict of interest and preclude a provider of securities or brokerage services from working on a specific project. One of ordinary skill in the art would appreciate that there are numerous barriers that may prevent a provider of securities transaction services to a registered user in accordance with embodiments of the present invention, and embodiments of the present invention are contemplated for use with and identification of any type of bar.

One aspect of the present invention is to use data provided to and/or stored in the system to identify and evaluate these potential barriers. These barriers may be weighted on a sliding scale, allowing for those with only potential barriers to still provide proposals, but their proposals may affected by their identified potential barrier weight. For instance, a provider of securities transaction services with a moderate potential for being barred from providing services on a specific project may still be allowed to view and submit a proposal on that project. However, their proposal may be i) ranked down due to the potential bar, ii) highlighted with a marker identifying the potential risk for bar, iii) categorized with other proposals similarly situated in relation to their potential risk for being barred, or iv) any combination thereof.

According to another embodiment of the present invention, if the weight of a potential barrier is high enough, a provider of securities transaction services may be prevented from viewing a project submission altogether. In this manner, the system serves to efficiently reduce the number of potential candidates by removing unqualified candidates from a pool of potential providers. Both the submitter of the project and the registered providers of securities compliance are benefited in this manner by reducing the overall amount of non-relevant data.

According to an embodiment of the present invention, once the submitter of a project has received one or more appropriate proposals from providers of securities related transactions, the submitter may select one or more of the providers of securities related transactionsto interview. The interview process may be conducted i) entirely through the system, ii) entirely through methods outside of the system (e.g., phone calls) or iii) any combination thereof. The interview process is option and may be skipped altogether if the submitter of a project desires to proceed with one or more providers of securities transaction services based on submitted proposals alone.

Once the submitter of a project has selected one or more providers of securities transaction services (the Providers) to handle their project, the actual servicing of the project may begin. Embodiments of the present invention may provide one or more tools to assist both the project submitter and the Providers successfully complete the project. For instance, the system may provide to the project submitter and one or more of the Providers i) an electronic workroom for data storage and sharing, ii) a collaborative meeting room with real-time, near real-time or asynchronous communication methods, iii) data comparison services (e.g., document comparison services), iv) databases of template or standardized forms (e.g., tax forms, SEC documents, template agreements), or v) any combination thereof. One of ordinary skill in the art would appreciate that there are numerous tools that the system may provide in accordance with embodiments of the present invention, and embodiments of the present invention are contemplated for use with the provision of any tool.

According to an embodiment of the present invention, instead of providers of securities business services waiting for projects to submit proposals on, the providers of securities business services may post proposals for standard services. For example, a provider of securities business services may post a proposal based on a standard hourly rate or fixed price proposal for a particular service. In this manner, registered users may simply select providers of securities transaction services based on their standing proposals.

According to an embodiment of the present invention, when a provider of securities transaction services post a proposal for standard services, registered users may still utilize the validation and certification features of the system as well as the features of the system that identify potential bars a particular provider of securities transaction services may have for providing the service to the registered user.

According to an embodiment of the present invention, once a project has been completed by one or more providers of securities business services, the submitting user may rate the services provided by each provider of securities transaction services and vice versa. In this manner, submitting users and providers of securities business services may build a reputation through the system.

According to an embodiment of the present invention, fees to be paid in relation to a project or proposal may be processed through modules of the present system. Modules of the present system are able to, for instance, escrow future fees, receive disbursement fees, invoice payments, assess late fees and calculate and receive tax payments. One of ordinary skill in the art would appreciate that modules in accordance with embodiments of the present system are capable of processing any type of payment or fee related transaction, and embodiments of the present invention are contemplated for use with any type of payment or fee related transaction.

According to an embodiment of the present invention, the systems and methods herein described may be further enhanced with the utilization of location based services (LBS). LBS are utilized on computing devices capable of determining a user's location via one or more methods. Methods for determining a user's location include, but are not limited to, global positioning systems (GPS), cellular or other wireless transmission triangulation and internet protocol (IP) address determinations. One of ordinary skill in the art would appreciate that there are numerous ways in which to determine the location of a user of a computing device, and embodiments of the present invention are contemplated for use with any manner of determining the location of a user of a computing device.

According to an embodiment of the present invention, LBS may be utilized by registered users submitting projects to define of limit geographical areas in which they are interested in receiving proposals from. In this manner, only registered users whose computing devices indicate they are in the limited geographic area selected by the user submitting a project may be allowed to view or search the project. Conversely, registered users posting a project may require responses from users outside of a specific geographic area. For instance, a registered users may desire to only receive proposals from users outside an area they were previously limited from taking action in (e.g., contractually limited by a non-competition clause).

According to an embodiment of the present invention, LBS may be utilized by registered users with a time based geographically limited need. For instance, a registered users may have a need to meet with another user at a specific time and place to receive a specific service. In this manner, the registered users may limit proposals to users with computing devices currently active in the geographically limited area or within a certain distance of the geographic area. An example of this is a registered users may have an immediate need for legal review of a hardcopy document. They registered users submit a project for an in person review of the document and limit the geographic area to a small, easy commutable area. In this example, only other users with computing devices currently active in the geographic area defined by the registered users would be able to view or search the project.

In another embodiment, registered users may tag areas, using their computing device, they frequent or they travel to on occasion. In this manner, if a registered users is looking for someone with knowledge of or access to a specific area, that knowledge or access could verified or verified in part through the use of LBS. According to an embodiment of the present invention, the tagging registered users may be required to use a computing device LBS confirmation method that indicates specific location (e.g., GPS) as opposed to generalized location (e.g., IP address).

According to an embodiment of the present invention, the system and methods herein may allow for two or more registered users who have connected through the methods and systems provided herein to locate each other and meet. This may be achieved through the use of computing devices with LBS enabled. For instance, two registered users who have finalized project and proposal may decide to meet at a first user's office to begin their project. The first user may tag his office and the address of the office may appear to the other user, for instance, in a shared project workroom. The other user may use his/her LBS enabled computing devices to find their way to the tagged address. Directions may be provided, for instance, via the LBS enabled computing device.

According to an embodiment of the present invention, LBS may be utilized to notify registered users of new posts in their vicinity. In this manner, when a new project becomes available that is looking for proposals from users in a specific geographically limited area, users in that geographically limited area may receive an alert if their LBS enabled computing device is active and confirms their appropriately located. Users may be alerted in any number of ways, including, but not limited to, SMS, Email, Phone Call or instant messaging. One of ordinary skill in the art would appreciate that there are numerous ways a user could be alerted to geographically specific opportunities, and embodiments of the present invention are contemplated for use with any manner of alerts.

According to another embodiment of the present invention, any of the previous systems and methods herein described may be utilized with LBS enabled computing devices to enhance the access and awareness of users. Any system or method previously described herein may be further enhanced through the use of LBS enabled computing devices.

### Exemplary Embodiments

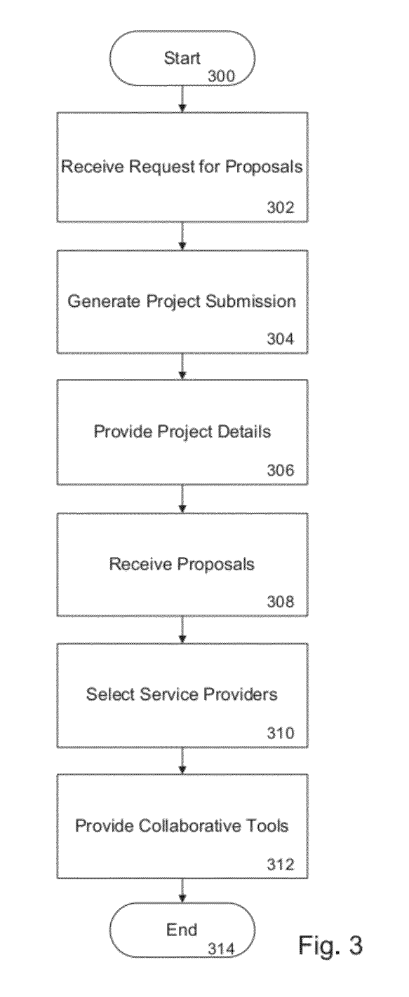

The following is an exemplary embodiment of a method for generating and delivering an event, as shown in FIG. 3. At step 300, the process starts with a user entering a request for proposals.

At step 302, the system receives the request for proposals from the user. In preferred embodiments, the system is configured to receive the request for proposals from a computing device associated with the user and the request for proposals itself is transmitted across one or more networks communicatively connected to the system.

At step 304, the system is configured to generate a project submission from the request for proposals received from the user. In order to affect this, the system utilizes the data points associated with the request for proposals and combines it with any data points it may have that are related to the user previously stored in one or more data stores associated with the system. A portion of the project submission is comprised of the project details, which define the project, milestones and other related project data.

At step 306, the system is configured to provide the project details to one or more service providers that may match the project details and potentially other criteria identified by the system and/or the user. In certain embodiments, the project details may be provided to one or more service providers that search for projects matching certain aspects of the project details.

At step 308, the system is configured to receive proposals from the one or more service providers interested in servicing the needs of the user with respect to the project. In a preferred embodiment, the service providers will provide proposals to the system from one or more computing devices communicatively connected to the system over one or more networks (e.g., the Internet).

At step 310, the user is able to select one or more service providers to service his/her one or more needs identified in the project details / request for proposals. Now that the user and service provider(s) have been matched, the project may commence.

At step 312, the system may be configured to provide collaborative tools, like those described above, in order to assist the user and service provider(s) with the task of completing the various project requirements and milestones.

At step 314, the process terminates.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A web-based system for facilitating a virtual connection of service providers in a securities industry with a user, the system comprising:
a data store configured to store a plurality of stored data points;
an application server operatively connected to said data store;
a first memory in the application server, said first memory containing computer-executable code stored in non-transitory memory that, when processed by said application server, performs steps comprising:
receiving a request to receive proposals for provision of one or more services related to securities business, from said user, wherein said request comprises one or more data points;
generating a project submission, comprising project details, from said request to receive proposals based at least in part on said one or more data points and said plurality of stored data points, wherein said project submission may be sent to or searched by providers of securities transaction services;
providing said project details to one or more securities transaction service providers;
receiving one or more proposals from one or more of said one or more securities transaction service providers;
receiving a set of one or more selected securities transaction service providers from said user; and
providing to said user and said set of one or more selected securities transaction service providers one or more collaborative tools.

2. The web-based system of claim 1, wherein said one or more securities transaction service providers have been previously verified.

3. The web-based system of claim 1, wherein said one or more services related to securities businesses comprise one or more of a broker dealer, a registered investment advisory firm, a private equity group, a hedge fund and a consultant.

4. The web-based system of claim 1, wherein said plurality of data points comprise one or more of a location of a project, a completion timeline, a required size of a service provider, a preferred size of a service provider, financial information related to the user and contact information.

5. The web-based system of claim 1, further comprising:
a second memory in the application server, said second memory containing computer-executable code stored in non-transitory memory that, when processed by said application server, performs steps comprising:
verifying said one or more securities transaction service providers; and
restricting access to said project details to at least one of said one or more securities transaction service providers.

6. The web-based system of claim 5, wherein said restriction is based at least in part on a conflict identified between said user and said at least one of said one or more securities transaction service providers.

7. The web-based system of claim 5, wherein said restriction is based at least in part on a conflict identified between said at least one of said one or more securities transaction service providers and a second one of said one or more securities transaction service providers.

8. A web-based method for facilitating a virtual connection of service providers in a securities industry with a user the method comprising the steps of:
receiving, at an application server, a request to receive proposals for provision of one or more services related to securities business, from a user, wherein said request comprises one or more data points;
generating a project submission, comprising project details, from said request to receive proposals based at least in part on said one or more data points and a plurality of stored data points, stored in a data store operably connected to said application server, wherein said project submission may be sent to or searched by providers of securities transaction services;
providing, from said application server, said project details to one or more securities transaction service providers;
receiving, at said application server, one or more proposals from one or more of said one or more securities transaction service providers;
receiving, at said application server, a set of one or more selected securities transaction service providers from said user; and
providing, from said application server, to said user and said set of one or more selected securities transaction service providers one or more collaborative tools.

9. The web-based method of claim 8, wherein said one or more securities transaction service providers have been previously verified.

10. The web-based method of claim 8, wherein said one or more services related to securities businesses comprise one or more of a broker dealer, a registered investment advisory firm, a private equity group, a hedge fund and a consultant.

11. The web-based method of claim 8, wherein said plurality of data points comprise one or more of a location of a project, a completion timeline, a required size of a service provider, a preferred size of a service provider, financial information related to the user and contact information.

12. The web-based method of claim 8, further comprising the steps of:
verifying said one or more securities transaction service providers; and
restricting access to said project details to at least one of said one or more securities transaction service providers.

13. The web-based method of claim 12, wherein said restriction is based at least in part on a conflict identified between said user and said at least one of said one or more securities transaction service providers.

14. The web-based method of claim 12, wherein said restriction is based at least in part on a conflict identified between said at least one of said one or more securities transaction service providers and a second one of said one or more securities transaction service providers.
